(19) United States
(12) Patent Application Publication
(10) Pub. No.: US 2026/0008537 A1
(43) Pub. Date: Jan. 8, 2026

(54) LOAD BALANCING AERIAL MUNITIONS DELIVERY SYSTEM

(71) Applicant: Dillon Casidhe Evan Ball, Kodiak, AK (US)

(72) Inventor: Dillon Casidhe Evan Ball, Kodiak, AK (US)

(21) Appl. No.: 19/124,920

(22) PCT Filed: Nov. 22, 2023
(86) PCT No.: PCT/US2023/080957

§ 371 Date: Apr. 28, 2025

Related U.S. Application Data
(60) Provisional application No. 63/384,707, filed on Nov. 22, 2022.
(60) Provisional application No. 63/510,005, filed on Jun. 23, 2023.
(60) Provisional application No. 63/519,871, filed on Aug. 16, 2023.

(51) Int. Cl. B64C 17/08; B64D 1/06; B64U 101/18

(52) U.S. Cl. CPC B64C 17/08; B64D 1/06; B64U 2101/18

(57) ABSTRACT

Apparatus and associated methods relate to an Aerial Munitions Loading and Delivery System (LBDS) configured to be mounted on an unmanned aerial platform, the LBDS having a munition holding unit including: a lever engaging frame configured to engage a interlock engagement frame of a fused munition, and a spring-loaded pin coupled to a top end of the munition configured to vertically support the munition, wherein, when the munition is loaded into the LBDS, the lever engaging frame includes an aperture configured to allow access to a safety pin of the munition. The lever engaging frame and the spring-loaded pin may, for example, exert a force in opposite directions along a horizontal axis to deactivate the munition, such that the safety pin can be removed without activating the munition.

### CROSS-REFERENCE TO RELATED APPLICATIONS

This application is a PCT application and claims the benefit of U.S. Provisional Application Ser. No. 63/384,707, titled “Load Balancing Aerial Munitions Delivery,” filed by Dillon Casidhe Evan Ball, on Nov. 22, 2022.

This application also claims the benefit of U.S. Provisional Application Ser. No. 63/510,005, titled “Load Balancing Aerial Munitions Delivery System,” filed by Dillon Casidhe Evan Ball, on Jun. 23, 2023.

This application also claims the benefit of U.S. Provisional Application Ser. No. 63/519,871, titled “Load Balancing Aerial Munitions Delivery System,” filed by Dillon Casidhe Evan Ball, on Aug. 16, 2023.

This application incorporates the entire contents of the foregoing application(s) herein by reference.

### TECHNICAL FIELD

Various embodiments relate generally to munition delivery systems.

### BACKGROUND

In the 21st century, modern warfare has evolved significantly due to technological advancements. Key components include precision-guided munitions, drones, cyber warfare, and information warfare, shaping military strategies around intelligence, surveillance, and adaptability.

Munitions are vital in modern warfare, encompassing various ammunition types used by armed forces. They range from small arms ammunition to explosives, rockets, and missiles, all rigorously designed for reliability, safety, and weapon system compatibility. Ongoing technological progress improves their range, accuracy, and lethality. Grenades are compact explosive devices with casing, explosives, a fuse, and safety pin. Removing the safety pin and activating the fuse enables them to deliver a high-energy blast, posing a threat to targets within their blast radius. Various types exist, including fragmentation, concussion, smoke, and flashbang grenades, with some featuring advanced electronic timers and safety mechanisms.

Drones, or Unmanned Aerial Vehicles (UAVs), serve diverse applications, from military surveillance to commercial purposes. They feature lightweight frames, engines, and sensors like GPS and cameras, capable of tasks like imagery capture, surveys, and payload delivery. Drones can be human-operated or autonomous, with ongoing technological advancements enhancing their capabilities across industries.

### SUMMARY

Apparatus and associated methods relate to an Aerial Munitions Loading and Delivery System (LBDS) configured to be mounted on an unmanned aerial platform, the LBDS having a munition holding unit including: a lever engaging frame configured to engage a interlock engagement frame of a fused munition, and a spring-loaded pin coupled to a top end of the munition configured to vertically support the munition, wherein, when the munition is loaded into the LBDS, the lever engaging frame includes an aperture configured to allow access to a safety pin of the munition. The lever engaging frame and the spring-loaded pin may, for example, exert a force in opposite directions along a horizontal axis to deactivate the munition, such that the safety pin can be removed without activating the munition.

Various embodiments of the LBDS may, for example, includes a servo motor operably coupled to the spring-loaded pin, such that, in a stowed mode, the servo motor pushes the spring-loaded pin towards the munition to keep it from falling and to maintain the lever engaging frame's engagement with the interlock of the munition.

Various embodiments of the LBDS may, for example, further include munition-retaining bolts configured to restrict a position of the munition in a loading position such that the grenade is prevented from moving when the safety pin is being removed in the loading position.

Various embodiments of the LBDS may, for example, include POGO ports configured to operate a digital fuse of the munition, such that the LBDS is capable of generating a timed explosion by activating the digital fuse.

Various embodiments of the LBDS may, for example, include a distance sensor, such that the LBDS activates the servo motor only at a height as a function of a fixed delay of the launched munition and a predetermined explosion height.

Various embodiments of the LBDS may, for example, include multiple lever munition holding units (MLMHU) symmetrically arranged in a horizontal plane, wherein, after the MLMHU are loaded with munitions, the LBDS is configured such that, after a first munition is released, a second munition opposite of the first munition is released to minimize a net torque generated by the releases of the first and the second munitions.

Various embodiments of the MLMHU may, for example, include a deployment unit having a rotatable dispensing plate operably coupled to multiple lids configured to withhold a grenade during transportation, wherein the rotatable dispensing plate is configured to rotate about a central axis and comprising a dispensing aperture such that only one of the multiple lids are capable of opening at one time.

Various munition embodiments may, for example, include an electronic fuse activated upon removal of the safety pin, wherein, in a transportation mode, the electronic fuse is interrupted by the interlock of the munition, and in a deployment mode, the electronic fuse activate the detonation mechanism of the munition based on an activation signal received from a timer and/or a sensor (e.g., a gyroscope, an impact sensor, a combination of sensors) of the electronic fuse. In some embodiments, the electronic fuse may, for example, include a communication unit configured to receive the activation signal.

Various embodiments may advantageously include a safety mechanism for holding multiple munitions in an unmanned aerial vehicle (UAV). A UAV may, for example, include a payload holding frame (PHF) configured to hold multiple munitions (e.g., M67 grenades, mortar shells, flares). The PHF includes a flange configured to engage an interlock engagement frame of a loaded munition and a pin configured to engage a lug of the payload. For example, in operation, when the PHF is loaded with multiple munitions, the flange and the pin may hold the munitions in a vertical position.

Various embodiments PHF may advantageously include a spring-loaded pin. For example, the pin may be coupled to a motor to activate a drop of the payload. The motor may, for example, include a servo motor. For example, the UAV may include a communication device to control the servo motor. For example, upon receiving an activation signal, the servo motor may draw back the pin in x direction to release the payload in y direction.

Various embodiments of the payload (e.g., the grenade, mortar shell, flare, etc.) may advantageously, be loaded into the PHF with its safety pin intact in the payload. For example, the safety pin may add an additional safety mechanism to advantageously prevent the payload from being accidentally activated during installation into the PHF. After the payload is securely loaded into the PHF, the safety pin of the payload may be removed because PHF is configured to hold a safety lever of the payload securely.

Various embodiments PHF may advantageously, include payload retaining bolts (PRBs). For example, the PRBs may be configured, once engaged, to fixedly restrict the position of the munition in a loading position. For example, when the PRBs are engaged with a grenade, the grenade may be prevented from moving even if the pin is accidentally retracted. Accordingly, an accidental detonation of the grenade caused by error of the servo motor is advantageously prevented.

Various embodiments of PHF may advantageously, include electronic ports (e.g., POGO ports). For example, the payload may include a grenade with a digital fuse. For example, the electronic ports may be activated by a signal received at the communication device to activate the digital fuse. In some implementations, the PHF may include a distance sensor. For example, the PHF may be configured to activate only at a height determined as a function of a fixed delay of the launched grenade and a predetermined explosion height.

Various embodiments PHF may advantageously, may be configured to hold multiple lever grenade holding units symmetrically arranged in a horizontal plane. In some implementations, the PHF may include a controller configured to release payload at alternative opposite positions. For example, after a first payload is released, a second payload opposite the first payload is released to minimize a net torque generated by the releases of the first and the second payload.

The details of various embodiments are set forth in the accompanying drawings and the description below. Other features and advantages will be apparent from the description and drawings, and from the claims.

### BRIEF DESCRIPTION OF THE DRAWINGS

FIG. 1A depicts an exemplary illustration of an exemplary load balancing aerial munitions delivery system (LBDS) deploying a ball shaped munition.

FIG. 1B depicts an exemplary illustration of an exemplary LBDS deploying a guided munition.

FIG. 1C depicts an exemplary illustration of an exemplary LBDS deploying a grenade munition.

FIG. 1D depicts an exemplary illustration of an exemplary deployment system including a lever engaging frame, spring loaded pin, safety pin, and motor configuration.

FIG. 1E is a block diagram depicts an exemplary LBDS.

FIG. 1G exemplary illustration of an exemplary LBDS deployment mechanism.

FIG. 1F depicts an exemplary ordinance with an exemplary arming device.

FIG. 2A exemplary illustration of an exemplary LBDS deployment mechanism.

FIG. 2B depicts an exemplary illustration of an exemplary load balancing aerial munitions delivery system.

FIG. 3A depicts an exploded front view of an exemplary LBDS motor configuration.

FIG. 3B depicts an exploded rear view of an exemplary LBDS motor configuration.

FIG. 4A depicts an exploded view of an exemplary extending longitudinal container.

FIG. 4B depicts an exploded view of a deconstructed exemplary extending longitudinal container.

FIG. 4C depicts an exploded view of a deconstructed exemplary extending longitudinal container.

FIG. 4D depicts an exploded view of a deconstructed exemplary extending longitudinal container.

FIG. 5A depicts an exploded view of a deconstructed exemplary extending longitudinal container.

FIG. 5B depicts a bottom view of a deconstructed exemplary extending longitudinal container.

FIG. 6A depicts an exploded view of a deconstructed exemplary extending longitudinal container.

FIG. 6B depicts a bottom view of a deconstructed exemplary extending longitudinal container.

FIG. 6C depicts an exploded front view of an exemplary LBDS motor and plate configuration.

FIG. 6D depicts a bottom view of an exemplary LBDS motor and plate configuration.

FIG. 7A depicts a side-exploded view of an exemplary LBDS container.

FIG. 7B depicts a top sectional view of an exemplary dispensing plate alongside a drive motor.

FIG. 8A depicts an exploded view of an exemplary LBDS deploying a munition.

FIG. 8B depicts a rear view of an exemplary LBDS deploying a munition.

FIG. 8C depicts a sectional view of an exemplary dispensing plate alongside a spring-loaded mechanism wherein a munition is being transferred from the first container to a second container.

FIG. 9A depicts a bottom exploded view of an exemplary LBDS.

FIG. 9B depicts a bottom cross-section view of a dispensing mechanism.

FIG. 9C depicts a perspective view of an exemplary LBDS after deploying 5 munitions.

FIG. 9D depicts a cross-section view of an exemplary LBDS after deploying 5 munitions.

FIG. 10A depicts a perspective view of an exemplary LBDS grenade munition configuration.

FIG. 10B depicts a bottom view of an exemplary LBDS grenade munition configuration.

Like reference symbols in the various drawings indicate like elements.

### DETAILED DESCRIPTION OF ILLUSTRATIVE EMBODIMENTS

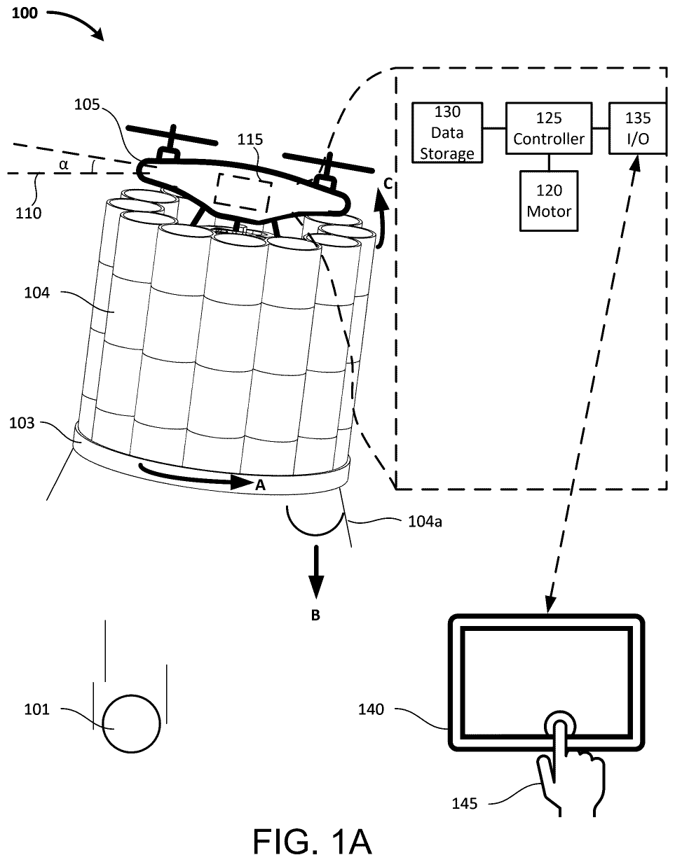

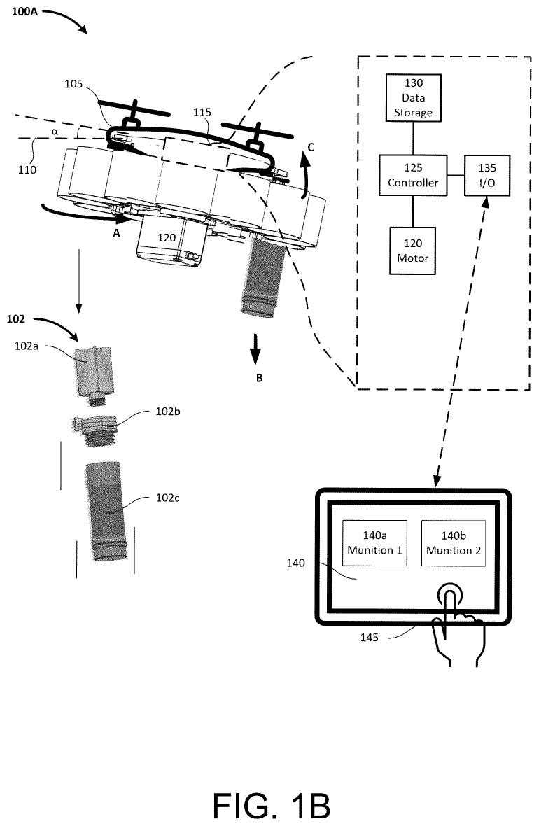

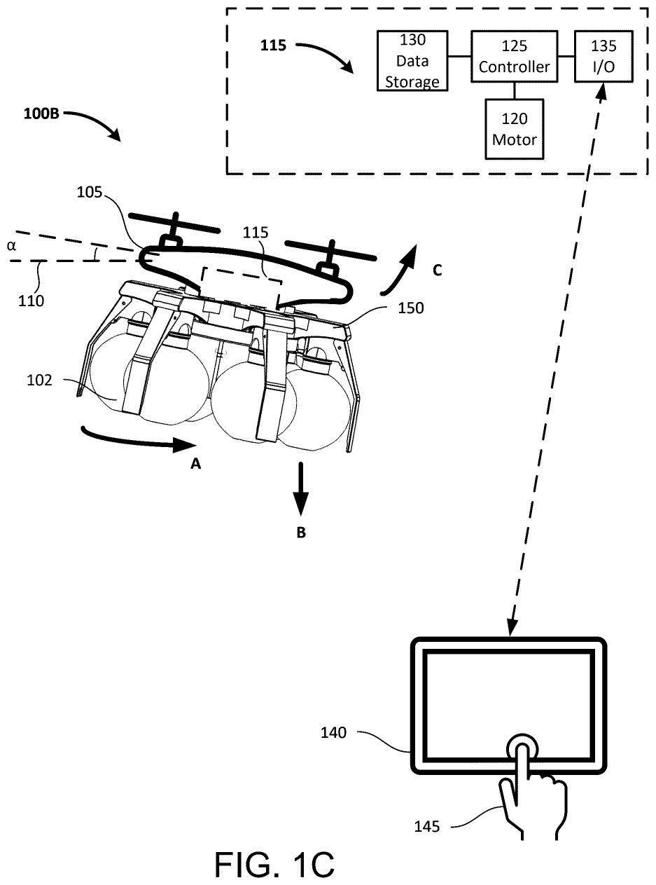

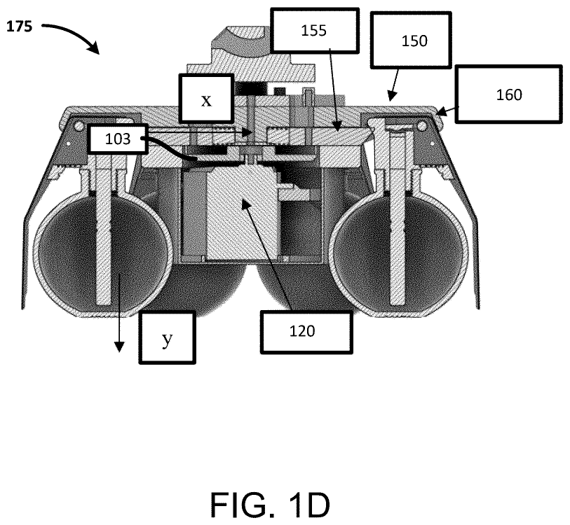

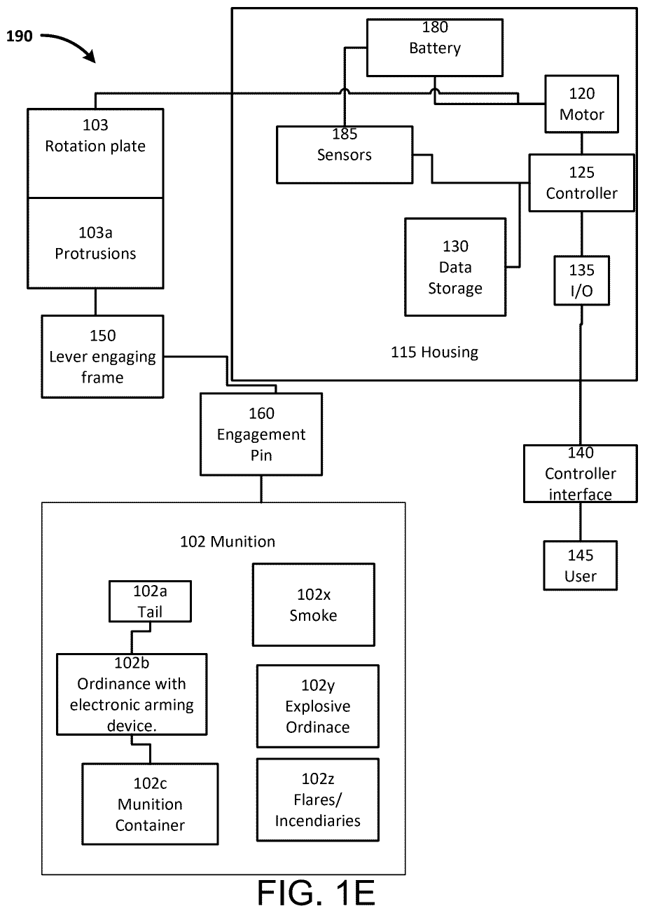

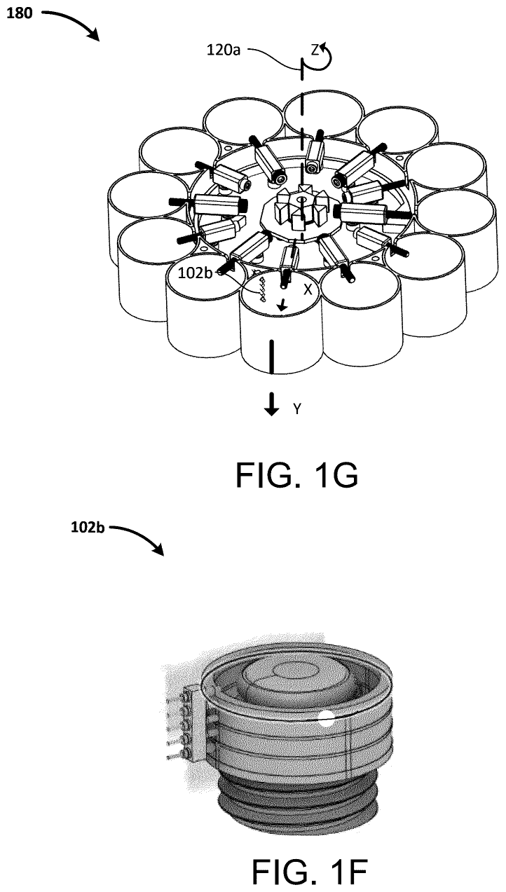

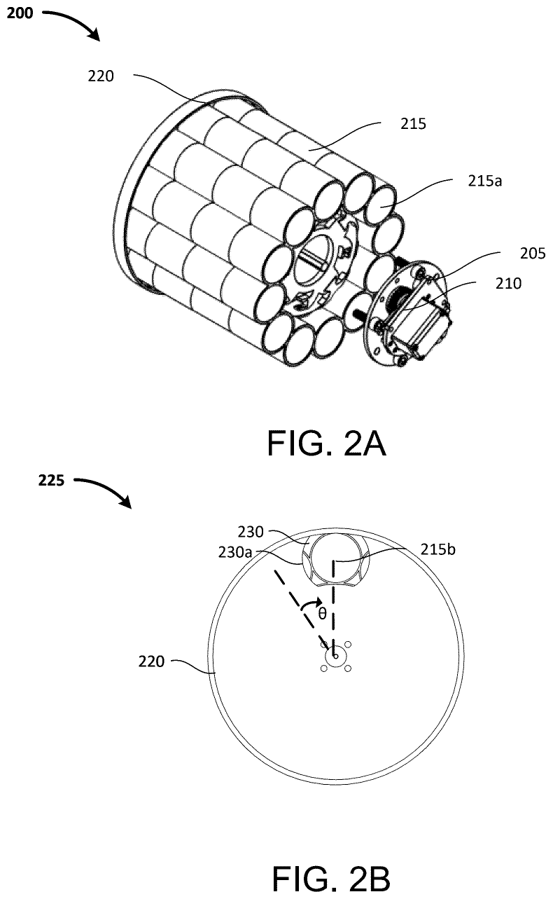

To aid understanding, this document is organized as follows. First, to help introduce discussion of various embodiments, a Load Balancing Delivery System (LBDS) system is introduced in a use case scenario, illustrative drawings, and block diagrams with reference to FIGS. 1A-1F. Second, that introduction leads into a description with reference to FIGS. 2A-10B of some exemplary embodiments of LBDS embodiments.

FIG. 1A depicts an exemplary illustration of an exemplary load balancing aerial munitions delivery system (LBDS) deploying a ball shaped munition. system (LBDS). In the exemplary illustration of an exemplary LBDS 100, cargo (e.g., munitions 101 in the depicted example, newspaper, medical supplies) are deployed from the exemplary LBDS. The munitions 101 are stored in a series of extending longitudinal tubes 104.

In this exemplary illustration of the exemplary LBDS 100, a release plate (e.g., dispensing plate 103) is interior to this particular embodiment of the LBDS and rotates in a motion A. Grooves may, for example, be located inside the dispensing plate 103 that align with a lid 104a. When the grooves of the dispensing plate 103 and the lid 104a align, the lid 104a may be released to open. When the lid 104a opens, the munitions 101 are released. The munitions 101 may, for example, be released by their weight due to gravity or be spring-loaded.

A remotely controlled unmanned aerial vehicle (UAV) 105 couples to the LBDS in the exemplary illustration of LBDS 100. For example, the remotely controlled UAV may be a multi-rotor drone, a fixed-wing drone, a single-wing drone, and/or a fixed-wing hybrid drone. For example, the remotely controlled UAV may include a quadcopter. In some implementations, for example, the UVA may be configured as an octocopter (e.g. drone with 8 flight motors).

After the munitions 101 are released, the munitions 101 fall in a direction B towards their target. The longitudinal tubes 104 are stationary when the dispensing plate 103 rotates. The munitions 101 contains mass. The longitudinal tubes 104 contains mass. The dispensing plate 103 contains mass. As mass outside the center of mass of the LBDS is rotated, a net torque C is generated. The center of mass of the LBDS changes as the munitions are released. The change of center of mass and the net torque C caused by the rotation of mass outside the center of mass can disrupt the flight of the UAV 105, as seen in a displacement of the pitch a degree α 110. The net torque C generated by the rotation of the LBDS may be calculated by taking the product of the distance of the mass being rotated from the center of mass times the amount of mass being rotated.

The dispensing plate 103, not the longitudinal tubes or munitions, is rotated in the LBDS while the UAV 105 is in flight to minimize the rotation of mass rotated outside the center of mass. As depicted, for example, the longitudinal tubes are not rotated, thus the longitudinal tubes do not generate a net torque. In the depicted example, the munitions 101 are not rotated, so the munitions generate no net torque.

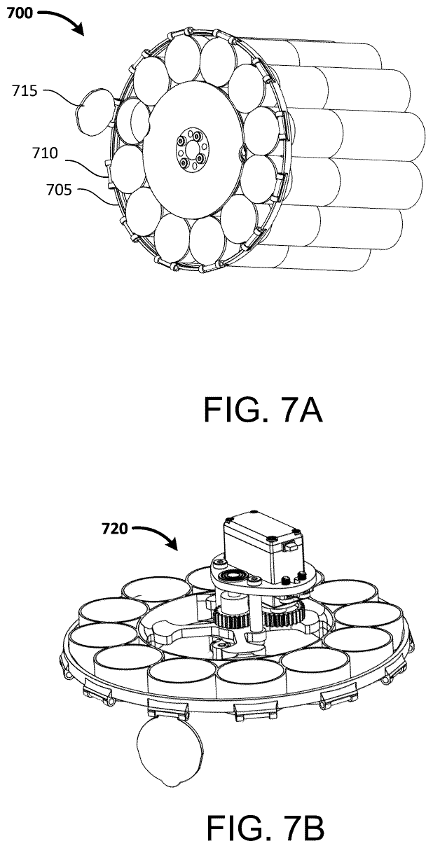

In the exemplary illustration of LBDS 100, the dispensing plate 103 is rotated along a shaft aligned with the center of mass of the LBDS when the munitions are stocked. The dispensing plate 103 embodiment may be further seen in FIGS. 7A-7D. As the dispensing plate 103 is rotated, the mass of the dispensing plate is rotated. The mass of the plate is distributed along a radius extending from the center of mass, so the net torque generated may be less than if the longitudinal tubes or the munitions were rotated because the longitudinal tubes and the munitions are located farther away from the center of mass of the LBDS.

A motor connected to the drive shaft mechanism may be operated in response to a remote controller. Operation of a remote-control trigger may cause the motor to rotate the drive shaft, releasing munitions from each tube in a predetermined (e.g., alternating) sequence. For example, the motor may operate in response to a flight controller. (e.g., upon reaching a predetermined coordinate such as a GPS coordinate). The motor may, for example, be self-powered. The motor may, for example, be integrated into the unmanned aerial vehicle and releasably coupled to the drive shaft.

In this exemplary illustration, a first munition is released, followed by a second munition opposite of the first munition. In the depicted example, the second munition is released opposite of the first munition to minimize the displacement of a. A net torque to the UAV is generated by the changing of the center of mass of the LBDS by releasing the first munition. The release of an opposite second munition may, for example, restore the center of mass to its original place, reducing the net torque from an offset center of mass to zero. Accordingly, variance from a target flight path may, for example, advantageously be reduced (e.g., by maintaining load balancing by offset release).

The aerial munitions delivery may be loaded with munitions (e.g., grenades, mortars, explosives, incendiaries). The munitions type may, for example, be an input to a function for a size of the interior diameter of the extending longitudinal tube. For example, a 30 mm tube may store a 30 mm grenade, a 40 mm tube may store a 40 mm grenade, and/or a 60 mm tube may store a 60 mm mortar. The LBDS is not limited to the delivery of ordinances but also may deliver medical supplies like tourniquets. The LBDS has commercial applications such as delivering newspapers, packages, or foam balls for children's toys.

The remotely controlled UAV 105 houses electronic systems 115. The electronic systems 115 includes a motor 120. The motor 120 is controlled by a motor controller 125. The motor is powered by an energy storage device. The energy storage device may, for example, be a battery power source. The motor controller 125 connects to the data storage device 130. For example, the data storage device may track and index the number of munitions expended. The data storage device may track the dispensing plate's current position compared to the available munitions. The motor controller 125 connects to an input and output device (I/O) 135. The input and output device 135 connect to a remote controller 140. The remote controller 140 is operated by a user 145. The remote controller may, for example, be a tablet, be a radio controller, or be satellite-linked. The remote controller may be handheld.

The indexing may cause containers on opposite sides of the drive shaft to be released sequentially in an alternating pattern. The containers may be opened by the rotating release mechanism (e.g., a rotating disc or plate). The containers may be closed by hinge lids. The lids may, for example, be held closed by the rotating release mechanism until an aperture in the release mechanism registered with the lids allows the lid to swing open due to gravity.

The electronic systems may operate a camera. The electronic systems may operate a GPS. The camera may identify targets not visible to an operating user over long distances. The camera may, for example, utilize a CPU to process software to highlight specific targets. The camera may store such data in the data storage.

The electronic system may operate a GPS. The GPS may, for example, index targets in the data storage device. The GPS may, for example, be used in indexing target locations in the data storage device. The GPS may, for example, be used in determining where the ordinances struck.

FIG. 1B depicts an exemplary illustration of an exemplary LBDS 100A deploying a guided munition. The exemplary LBDS 100A includes an ordinance 102. The ordinance includes a tail 102a. The ordinance 102 include an armed explosive 102b with an electronic pin trigger. The ordinance 102 includes a container 102c.

The electronic pin trigger may, for example, include POGO pins. The POGO pins may, for example, touch the metal rings on the munition. These pins may, for example, be used for data communication between the dropper and the munition.

A microcontroller may, for example, be included within the munition. The microcontroller may, for example, activate with an electronic detonator with the munition when actuated. The munition may, for example, be actuated by an electronic signal sent by an authorized user. The electronic communications may, for example, be encrypted.

A MOSFET or relay may, for example, be included to complete the circuit between the munition's on board battery and the on board electric detonator.

The remote controller 140 may, for example, include a display interface. The display interface may, for example, include a munitions option 140a. The display interface includes a munitions option 140b. A user 145 may, for example, pick between munition one and munition two to deploy. Munition one may, for example, include a flare, smoke grenade, and/or flash grenade. Munition two may, for example, include an explosive. A user may, for example, selectively engage ordinance types to complete mission objectives. The mission objectives may, for example, be given by the United States military for example. The mission objectives may, for example, be given by a police captain to junior officers during a hostage situation.

The munition may, for example, be toggled by rotating an interior plate containing protrusions (e.g. cams). The interior protrusions may, for example, engage pins releasing an ordinance in a direction B downward.

In some embodiments, the LBDS may, for example, have lighter embodiments. The LBDS may, for example, include shorter longitudinal tubes, such that the munition is exposed while filing. The munition may, for example, include a retention mechanism, such that once the munition is inserted the munition is releasably coupled to the LBDS in a locked mode. The munition may, for example, be released after a trigger is activated by the circular movement of a plate with protrusions such that the protrusions activate the trigger releasing and dropping the munition from the LBDS. The munitions may, for example, drop simultaneously from either side as to minimize weight offset and moments caused by deploying munitions aerially. In some embodiments, the munitions may, for example, drop from alternating from either side to minimize the weight offset.

The trigger may, for example, include a pin. The pin may, for example, interact with the protrusion such that the protrusion wedges the pin to activate. The pin may, for example, pull back by a spring mechanism such that the munition drops from the LBDS.

In some embodiments, the wedge may, for example, retract the pin causing the drop of the munition. The spring may, for example, return the pin to its original position in order to secure a munition after the insertion.

The protrusions may, for example, include 2 different faces. The faces may, for example, travel laterally to activate the pins. The protrusions may, for example, include two different cam faces. Each cam may, for example, act with every other pin.

An alternating dispersal of the munitions of the LBDS may, for example, act such that the weight is evenly dispersed across the LBDS. In some embodiments, an electronic system that actuates the pins may, for example, be used instead of a singular motor. The electronic system may, for example, include individual servo's at each munition's opening.

The pin may, for example, be pushed out of the way by the protrusion wedge such that the pin springs back to its original placement which may, for example, allow free entry and exit into the munition opening of the LBDS.

In some embodiments, the LBDS may, for example, be printed completely with 3-D printing techniques. The LBDS may, for example, be casted with molds. The LBDS may, for example, be mass produced in factories and be shipped overseas. The LBDS may, for example, be sold in kits along with ammunition. The LBDS may, for example, be sold in a kit included with a 3D printer such that multiple LBDS may, for example, be manufactured from a 3-D printer.

FIG. 1C depicts an exemplary illustration of an exemplary LBDS 100B deploying a grenade munition. The exemplary illustration of the exemplary LBDS 100B includes a dispensing plate is interior to this particular embodiment (not shown in FIG. 1C but depicted in cross-section view FIG. 1D) of the LBDS and rotates in a motion A. Grooves may, for example, be located inside the dispensing plate 103 that align with a lid 104a.

After the munitions 101 are released, the munitions 101 fall in a direction B towards their target. As mass outside the center of mass of the LBDS is rotated, a net torque C is generated. The center of mass of the LBDS changes as the munitions are released. The change of center of mass and the net torque C caused by the rotation of mass outside the center of mass can disrupt the flight of the UAV 105, as seen in a displacement of the pitch a degree a 110. The net torque C generated by the rotation of the LBDS may be calculated by taking the product of the distance of the mass being rotated from the center of mass times the amount of mass being rotated.

FIG. 1D depicts an exemplary illustration of an exemplary deployment system including a lever engaging frame, spring loaded pin, safety pin, and motor configuration engagement frame system 175. The exemplary LBDS 100B includes directed to a safety mechanism for holding multiple grenades in an unmanned aerial vehicle (UAV). As shown in FIG. 1C, a UAV 105 includes a payload holding frame (PHF) 150 configured to hold, for example, multiple grenades (e.g., M67 grenades). The PHF 150 includes a flange 160 configured to engage a safety spoon (interlock of the munition and/or interlock engagement frame of the LVDS) of a loaded grenade and a pin 155 configured to engage a lug of the payload (for example by use of the protrusions of a rotation plate 103 being rotated by motor 120 may, for example, angle the pin downward such that the payload is released). For example, in operation, when the PHF is loaded with multiple grenades, the flange and the pin may hold the grenades in a vertical position.

The pin, in some implementations, may be spring loaded. For example, the pin may be coupled to a servo motor to activate a drop of the payload. The UAV includes a communication device 140 to control the servo motor 120. For example, upon receiving an activation signal (though the input/output module 135 to the motor controller 125), the servo motor may draw back the pin in x direction to release the payload in y direction.

In various implementations, the payload (e.g., the grenade) may be loaded into the PHF with its safety pin intact in the payload. For example, the safety pin may add an additional safety mechanism to advantageously prevent the payload from being accidentally activated during installation into the PHF. After the payload is securely loaded into the PHF, the safety pin of the payload may be removed because PHF is configured to hold a safety lever of the payload securely.

In some implementations, the PHF may further include payload retaining bolts (PRBs). For example, the PRBs may be configured, once engaged, to fixedly restrict the position of the grenade in a loading position. For example, when the PRBs are engaged with a grenade, the grenade may be prevented from moving even if the pin is accidentally retracted. Accordingly, an accidental detonation of the grenade caused by error of the servo motor is advantageously prevented.

In some implementations, the PHF may include electronic ports (e.g., POGO ports). For example, the payload may include a grenade with a digital fuse. For example, the electronic ports may be activated by a signal received at the communication device to activate the digital fuse. In some implementations, the PHF may include a distance sensor. For example, the PHF may be configured to activate only at a height determined as a function of a fixed delay of the launched grenade and a predetermined explosion height.

As shown, the PHF may be configured to hold multiple lever grenade holding units symmetrically arranged in a horizontal plane. In some implementations, the PHF may include a controller configured to release payload at alternative opposite positions. For example, after a first payload is released, a second payload opposite the first payload is released to minimize a net torque generated by the releases of the first and the second payload.

In some embodiments of the LBDS grenade munition configuration, the release mechanism may, for example, serve dual roles in grenade deployment. When the pin is pulled back, the spring-loaded mechanism locks the grenade securely in place, preventing it from moving. This lock relies on the pins connected to bolts that engage with the grenade, ensuring that they are fully extended and locked in place for safe deployment. Additionally, the release mechanism acts as a forward assist, assisting in loading the grenades. This feature enables users to unload the grenade by pushing on the pin, making it safe for handling.

The release mechanism also incorporates a mechanical safety mechanism that can be toggled between safe and armed positions. When engaged, the safety ensures that the pins are fully extended and securely locked in place, preventing accidental deployment. A servo motor could be integrated to remotely control the safety, allowing it to be disabled when the drone is in flight.

For loading the grenades, the grenades may, for example, be loaded one by one, with each grenade rocking into place and then being checked to ensure it is securely locked. A user may, for example, inspect and, if necessary, straighten any deformed or misshapen spoons on the grenades to facilitate smooth locking. The mechanism is designed to handle the loading process, with a simple reset mechanism available to relieve internal tension if needed. Overall, the release mechanism may, for example, advantageously securely hold and deploy grenades while ensuring safety and preventing accidental releases during drone operations.

In some implementations, the LBDS device can be ground-tested for demonstration purposes. A user may, for example, activate the device by pressing the drop button or by connecting it to a Sky Raider system. When switching the hook from the closed to the open position, a user may, for example, trigger the device to deploy. The LBDS device may, for example, be configured for fully automatic operation. A user may, for example, initiate the deployment, by pushing the motor's forward button on a remote controller to actuate the rotation of the motor, and the input of the motor's rotation will activate the mechanism, allowing it to release its payload.

FIG. 1E is a block diagram depicts an exemplary LBDS system 190. The LBDS includes munition 102. The exemplary munition 102 includes a tail 102a. The tail may, for example, be rigid. The tail may, for example, in some embodiments be controlled to control drop targeting. The tail may, for example, be controlled by a computer program to autonomously hit desired targets. The tail may, for example, be directed by radio wave frequencies from the drone to have a controlled drop.

The exemplary munition 102 may, for example, include smoke munitions 102x. The exemplary munitions 102 may, for example, include explosive ordnance 102y. The exemplary munitions 102 may, for example, include flares and/or incendiaries 102z.

The exemplary munition 102 is deployed after a displacement of the munition interlock, dropping the munition. The munition interlock is formed by the lever engaging frame 150 and the horizontal engagement pin 160. The munition 102 is deployed after the horizontal retraction of said horizontal pin 160. The horizontal retraction of the pin 160 is caused by the rotation of the rotation plate 103. The rotation plate may, for example, include protrusions 103a that actuate the spring-loaded springs. For example, 2 opposing protrusions on the opposite side of the rotation plate may, for example, release two munitions simultaneously achieving a load balancing effect that mitigates the net torque from the loss of weight of munition, because the moments created are opposite and similar to each other (similar mass, and distance from center of mass), so the moments are opposite to each other moments minimizing the net effect on the aircraft. The rotation plate 103 is coupled to a motor 120. The motor may, for example, include a servo motor.

A housing 115 may, for example, house the motor and components. The housing 115 may, for example, include a battery 180. The housing 115 may, for example, include sensors 185. The sensors may, for example, be distance sensors. Distance sensors may, for example, be included in the munitions to affect deployment of the munition. The motor 120 is coupled to a motor controller 125. The motor controller is coupled to a data storage device, configured, for example, to keep track of the type of munitions and which munitions when deployed. The motor controller 125 is coupled to an input and output device 135. The input and output device 135 is coupled to a controller interface 140. The controller interface 140 in this block diagram is operate by a user 145. A user may, for example, actively control the deployment of munitions and/or autonomously set parameters to control the deployment of munitions at set positions (for example, positions determined by GPS, and/or positions outside the user's line of sight).

FIG. 1G exemplary illustration of an exemplary LBDS deployment mechanism 180. The LBDS deployments system 190 includes a longitudinal axis 120a extending along the shaft of the motor located at the center of mass of the UAV. The LBDS deployment system 180 includes a plate with protrusions. The plate may, for example, include one or more protrusions. The protrusions may, for example, be different shapes to offset loading conditions on the opposite side of the LBDS such that the LBDS may, for example, balance from the deployment of ordinance weight at the same time. The plate with protrusions may, for example, rotate in a direction 2A counter-clockwise. In some embodiments the plate may, for example, spin clockwise. The spin direction may, for example, depend on the structure of the cams.

The LBDS deployment system 200 includes a retention mechanism 102b. The retention mechanism may, for example, physically includes pins coupled to a spring mechanism. The retention mechanism may, for example, include additional digital pogo pins 102b. The physical pins may, for example, be engaged after a person places an ordinance within the longitudinal container. The ordinance may, for example, protrude from the longitudinal container. The clockwise rotation 2A may, for example, cause the pins to retract inward in a motion 2B. The retraction of the physical spring loaded pins may, for example, cause the ordinance to drop downward in a direction 2C. The pins may, for example, engage outward in motion 2B after an ordinance is stored in the LBDS in a motion 2C upward.

FIG. 1F depicts an exemplary ordinance with an electronic arming device. The exemplary munition 102 includes an ordinance with an electronic arming device 102b. The ordinance may, for example, armed after the pins are released. The ordinance may, for example, be non-explosive state when not armed. The ordinance may, for example, include an explosive state after being armed. The ordinance may, for example, be armed after being released by an electronic pin. The ordinance may, for example, in some embodiments be armed mechanically.

In some embodiments, the pins may, for example, include POGO pins that touch the metal rings on the munition. The pins may, for example, be used for data communication between the dropper and the munition.

In some embodiments, a microcontroller with the munitions activates the electric detonator within the munition when appropriate. The munition may, for example, be activated by a MOSFET or a relay to complete the circuit between the munition's onboard battery and on board assembly.

The exemplary munition 102 includes a container 102c. The container may, for example, hold the ordinance and couple to the tail. The container may, for example, be cylindrical. The containers may, for example, be rigid. The container may, for example, include a head such that includes aerodynamic properties (i.e. spherical, or pointed head) to direct container vertically downward without turbulence, pitching, yawing, rotating, and/or uncontrolled spin. The container may, for example, include fins to increase control of the container when dropping. The fins may, for example, be rigid. The fins may, for example, be controllable by radio wave. The container may, for example, include smart technology to identify targets.

In some embodiments, the munitions may, for example, include altimeters (e.g. laser, radar, pressure gauge, etc.) to explode after reaching a certain altitude. The munitions in some embodiments may, for example, air burst. The munitions in some embodiments be armed by a function of the number of triggers not engaged (e.g. 3 pins of 5 pins not engaged arms device).

The pins may, for example, be used for communicating data to the microcontroller. The data sent over these pins may, for example, instruct the controller to arm and/or disarm the munition.

Munitions may, for example, include shrapnel and other debris material to increase blast range and target area. In some embodiments, the munitions may, for example, create a noise when armed and before detonation.

In some embodiments, an airburst ordinance may, for example, include a laser range finder on the dropper. The range finder may, for example, pass data such as the altitude to the microcontroller of the munition. The microcontroller may, for example, then calculate the time of flight and count down from the time munition is released to the desired burst location.

In some embodiments, the spring may, for example, be easier to load and pushing via a retention on/off mechanism differential. In some embodiments, the retention mechanism may, for example, may be used without a micro-controller, because it may not be important to the user to know where the motor is and just to deploy the munitions strategically over a target. The target may, for example, include enemy soldiers. The target may, for example, include entrenched positions of enemy soldiers. The target may, for example, be a terrorist and/or enemy combatant in a conventional war and/or armed conflict.

The motor position location may, for example, allow for the precise alignment of the motor to align with the tube to drop the ordinance. In some embodiments with retention pins, turning the motor on will cause the munitions to drop based on the cam and retention mechanism interaction that begins with the motor rotating the cam.

In some embodiments, the laser altimeter may, for example, be used to prevent flames and/or explosions with the drone (e.g. allow a certain distance between drone and explosive before exploding such that the drone avoids the shock wave).

In some embodiments, the LBDS may, for example, include a sensor (e.g. switch, etc.) to detect the presence of ammunition within the container. The LBDS may, for example, provide real time ammunition count. The LBDS may, for example, allow for prolonged engagements by releasing munitions one at a time such that the drone does not deploy load aimlessly. The LBDS may, for example, reduce the waste of munitions and/or excessive use of munitions on a singular target.

In some embodiments, the LBDS may, for example, swap between different munitions (e.g. ammo supplies, smoke grenade, flash bang, and/or explosive charge). The LBDS may, for example, be used by police officers in engagements with hostile targets. The LBDS may, for example, be used by SWAT teams to storm hostile zones by deploying flash/and or smoke grenades. Drops may, for example, include trails such that a user can detect where ordinance is dropping as drone deploys ordinance.

FIG. 2A exemplary illustration of an exemplary LBDS deployment mechanism. FIG. 1B depicts an exploded side view of an exemplary LBD 200. The exemplary LBDS 200 includes a coupler 205 to an unmanned aerial vehicle. The exemplary LBDS 200 includes a drive shaft mechanism 210. The exemplary LBDS 200 includes a series of extending longitudinal containers 215. The exemplary LBDS 200 includes a dispensing plate 220. The extending longitudinal containers 215 are disposed circumferentially around a drive shaft mechanism 210. Each extending longitudinal container 215 has a proximal end 215a and a distal end 215b. The drive shaft mechanism 210 is capable of rotating the dispensing plate 220. The dispensing plate is located at the distal end 215b of the extending longitudinal containers 215. The rotation of the dispensing plate 220 allows munitions stored in the containers to be released due to gravitational force. The dispensing plate may be rotated to open containers in a predetermined sequence.

FIG. 2B depicts an exemplary illustration bottom view 225 of an exemplary load balancing aerial munitions delivery system. The dispensing plate 220 (e.g., rotating plate) includes an aperture 230. The rotating plate is displaced an angle theta, to release the munition. Adjacent munitions are held by the material exterior 230a of the aperture 230.

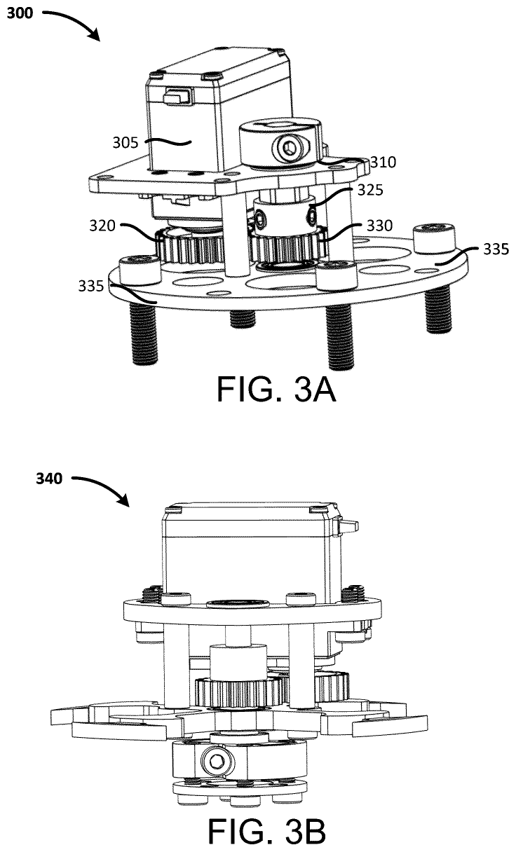

FIG. 3A depicts a view of an exemplary LBDS motor configurations including an exemplary motor drive shaft 300. The exemplary motor drive shaft 300 includes a motor 305. The motor 305 may, for example, be a servo motor. The motor 305 is adjacent to a drive shaft coupling 310. The drive shaft coupling 310 supports an adjoining drive shaft. The motor 305 and drive shaft coupling 310 is structurally attached to a plate mechanism 315. The plate mechanism may, for example, provide structure for the exemplary motor drive shaft. The drive shaft coupling 310 is attached by a shaft to a first gear 320. The first gear meshes together with a second gear 330. The second gear 330 couples to a shaft containing a bolt coupler 325. The second gear may, for example, be used to rotate a shaft that rotates the bottom dispensing plate of an exemplary LBDS. The drive shaft spun by the second gear is attached to an exemplary coupler 335 for an unmanned aerial vehicle that is capable of housing an exemplary motor drive shaft.

FIG. 3B depicts an exploded view of an exemplary motor drive shaft 340. The exemplary motor drive shaft is used inside the dispenser container surrounded by the a series of extending longitudinal containers 215.

In some embodiments, the motor may not be directly attached to the container of the LBDS, but be attached to a drone with a motor. In other implementations, the drone may not have a motor, and the container of the LBDS may house a motor separate from the drone.

The exemplary motor drive shaft 300 may include a gear box. A gear box may, for example, receive an input torque a rotation driven by the motor. The gear box, may for example, output a different torque or rotation speed. The relationship between a number of teeth on the first gear and the number of teeth on the second gear is shown below with the following gear ratio formula.

$$n\_ 1 / n\_ 2 = τ\_ 1 / τ\_ 2 = ω\_ 1 / ω\_ 2$$

Where n_1/n_2 is the ratio between a first number of teeth n1 on the first gear and a second number of teeth n2 on the second gear. Where τ_1/τ_2 is the ratio between an input torque τ_1 on the first gear and an output torque τ_2 on the second gear. Where ω_1/ω_2 is the ratio between a first rotational velocity ω_1 on the first gear and an output rotational velocity ω_2 on the second gear.

τ_1 may, for example, be the input torque of the motor. τ_2 may, for example, be the output torque used to rotate the dispensing plate. τ_2 may, for example, be calculated by taking the product of τ_2 and the gear ratio n_2/n_1.

In some implementations, the motor may not be adjacent to a drive coupling shaft, but the motor may be directly connected to the shaft used to rotate the dispensing plate. Servo motors may, for example, have different levels of rotational degree control. A servo motor may only be able to rotate 90°. A servo motor may only be able to rotate 180°. A servo motor may only be able to rotate 270°. Some servo motors may, for example, not be capable of rotating 360°.

The gear box may, for example, enable a servo motor to have the capability to rotate an output drive shaft 360°. The gear box may, for example, enable a 90° motor to rotate an output drive shaft 360°. The gear box may, for example, enable a 180° motor to rotate an output drive shaft 360°. The gear box may, for example, enable an 270° motor to rotate a output drive shaft 360°. In some implementations of a servo motor with less than 360° rotation, a gear box may, for example, be used to rotate the dispensing plate 360°.

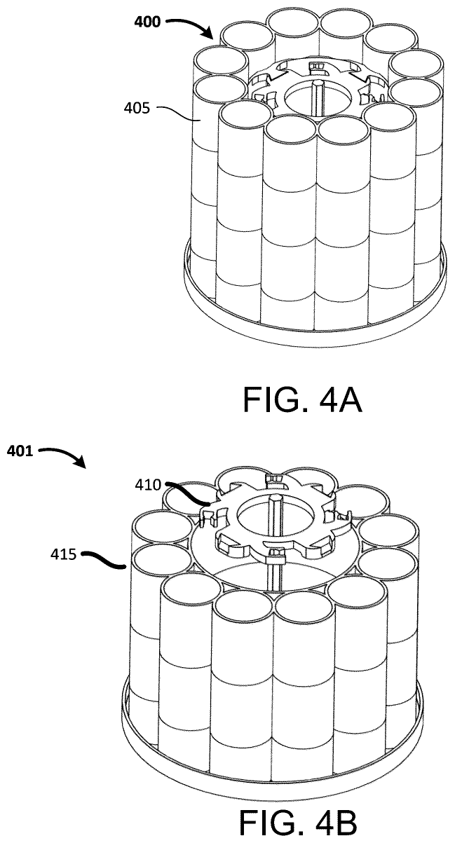

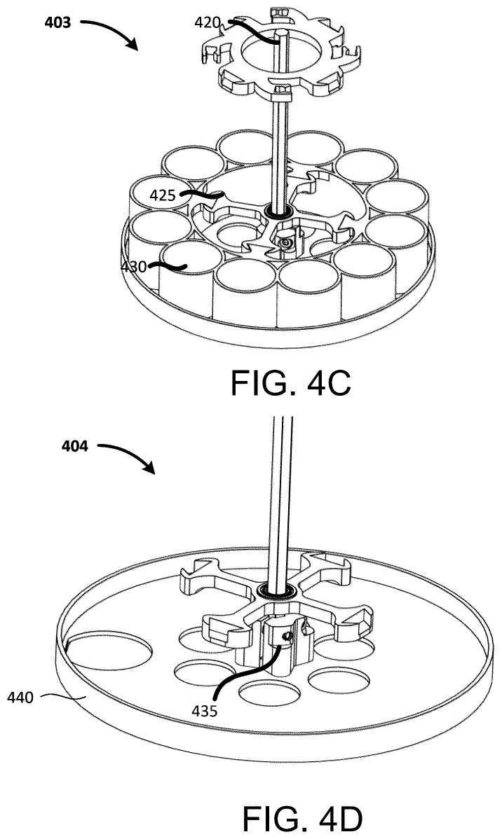

FIG. 4A-4D depicts an exploded view of an exemplary extending longitudinal container 400, a first deconstructed view 401, a second deconstructed view 403, and a third deconstructed view 404. The exemplary extending longitudinal container 400 includes a top sectional container 405. The top sectional container 405 couples to a coupler 410. The coupler 410 connects to an unmanned aerial vehicle. The exemplary extending longitudinal container 400 includes interior sectional containers 415. The exemplary extending longitudinal container 400 includes a drive shaft 420. The drive shaft 420 couples to a bottom coupler 425. The bottom coupler 425 couples to a bottom sectional container 430. The shaft couples to a dispensing plate coupler 435. The dispensing plate coupler 435 couples to a dispensing plate 440. The dispensing plate may be beneath the bottom sectional container. The dispensing plate 440 has a single primary dispensing hole 445. The dispensing plate 440 has secondary dispensing holes 450.

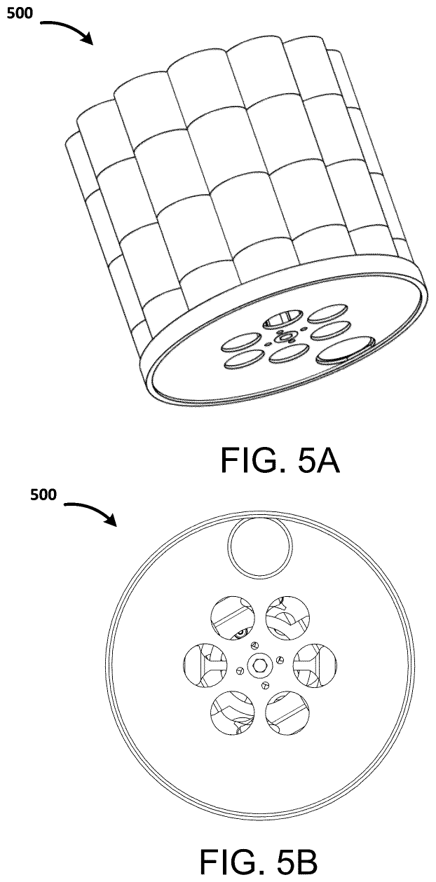

FIG. 5A-5B depicts an exploded view of a deconstructed exemplary extending longitudinal container 500.

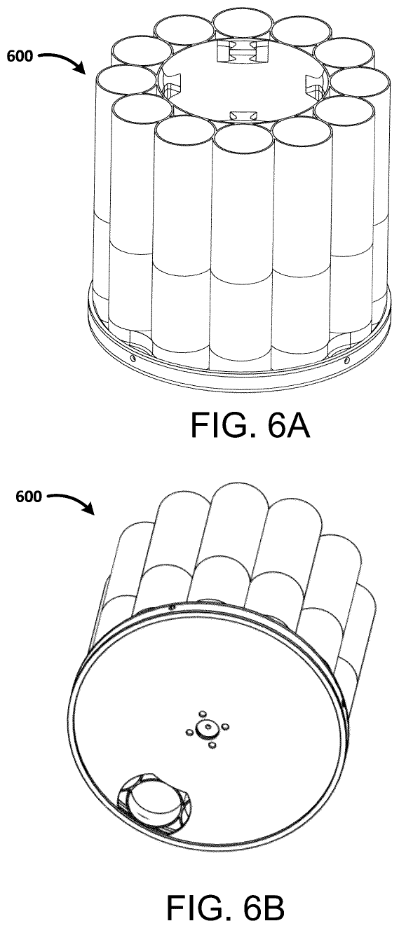

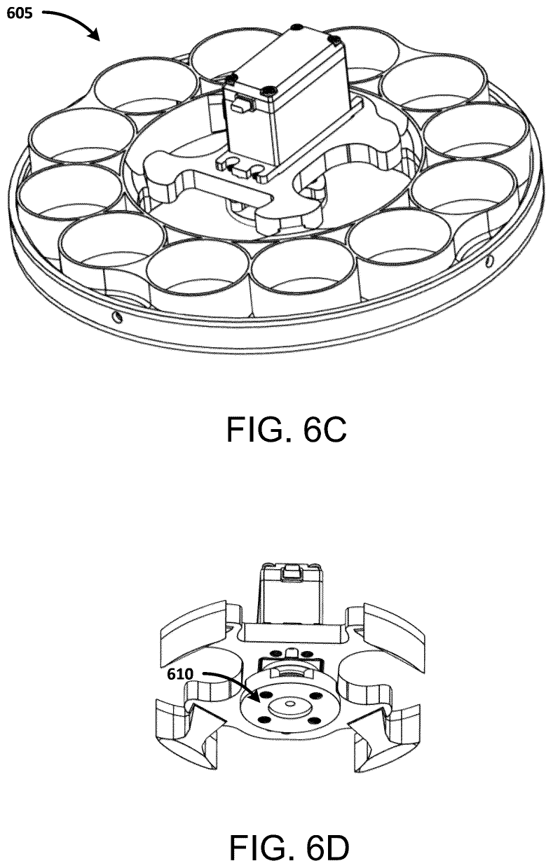

FIG. 6A-6D depicts an exploded view of a deconstructed exemplary extending longitudinal container. An exemplary drive motor 605 rotates a drive shaft in line with the motor 360°. The exemplary drive motor 605 is connected to a drive shaft coupler 610. The drive shaft couple may, for example, be used to rotate a dispensing plate.

In other implementations, the servo motor may not be capable to rotate an input drive shaft 360° to release all the contents loaded in the extending longitudinal containers without a gear box. In these instances, the servo motor may, for example, rotate an input drive shaft connected a gear box to rotate an output shaft 360°.

FIG. 7A-7B depicts a top side-exploded view of an exemplary LBDS container alongside a drive motor. The LBDS 700 includes a dispensing plate 705. The dispensing plate 705 attaches to an opening lid coupler 710. The opening lid coupler 710 couples to a lid 715. The lid covers an opening of the LBDS 700. The LBDS 700 includes a delivery mechanism 720. The delivery mechanism includes a motor and a drive shaft to spin the bottom sectional container.

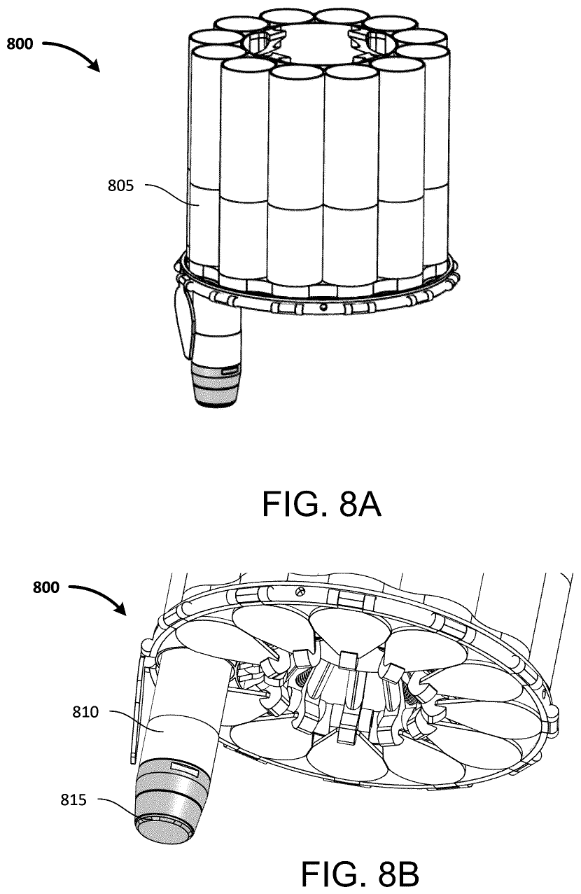

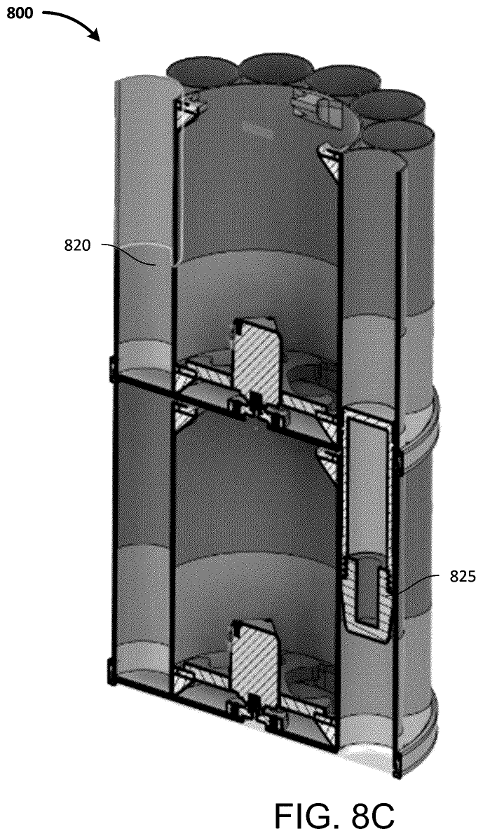

FIG. 8A-8C depicts a rear view of an exemplary LBDS deploying a munition and a sectional view of an exemplary dispensing plate alongside a spring-loaded mechanism wherein a munition is being transferred from the first container to a second container.

The LBDS 800 has a first extending longitudinal container 805. The first extending longitudinal container 805 couples to a second extending longitudinal container 810. The first extending longitudinal container 805 couples to the second extending longitudinal container 810.

The first extending longitudinal container 805 is shown dispensing a munition container 815. The munition container 815 is being transferred to the second extending longitudinal container 810. The munition container may, for example, carry explosive materials. The munition container may, for example, carry medical supplies. The munition container may, for example, carry a GPS tracker dispenser. The munition container may, for example, carry a package. The munition container may, for example, carry ammunition. The munition container may, for example, carry dispensable flares. The dispensable flares may highlight targets after being deployed from the LBDS.

The LBDS 800 includes a motor mechanism 820 A drive shaft connected to a motor mechanism 820 may rotate the first extending longitudinal container 805 to transfer munitions contained within the first extending longitudinal container 805 to the second extending longitudinal container 810. For example, the munitions in the first extending longitudinal container may rotate to transfer munitions to the second extending longitudinal container. The second extending longitudinal container may drop munitions from the container onto targets.

The first extending longitudinal containers may be spring-loaded. The second extending longitudinal containers may be spring-loaded. For example, the motor may rotate an output mechanism that makes contact with a switch connected to each lid of each individual longitudinal container. The switch may be connected to the lip of the dispensing plate. After the motor rotates the output mechanism to make contact with the switch, the lid may open releasing the contents of the longitudinal container.

In some implementations, for example, the LBDS modules may be stacked on top of each other, as shown. For example, the tubes may be axially aligned (e.g., along a longitudinal axis). A lower LBDS canister may be emptied first. The upper LBDS canister may, for example, be emptied second. More than two modules may be stacked end-to-end on top of each other, for example. Accordingly, multiple rounds of cargo may be carried and sequentially dispensed, for example.

In some implementations, for example, the upper canisters and lower canisters may be synchronized. For example, an axially aligned upper and lower canister may be simultaneously released. For example, multiple cargo elements (e.g., grenades) may be released simultaneously from an effectively extended-length tube.

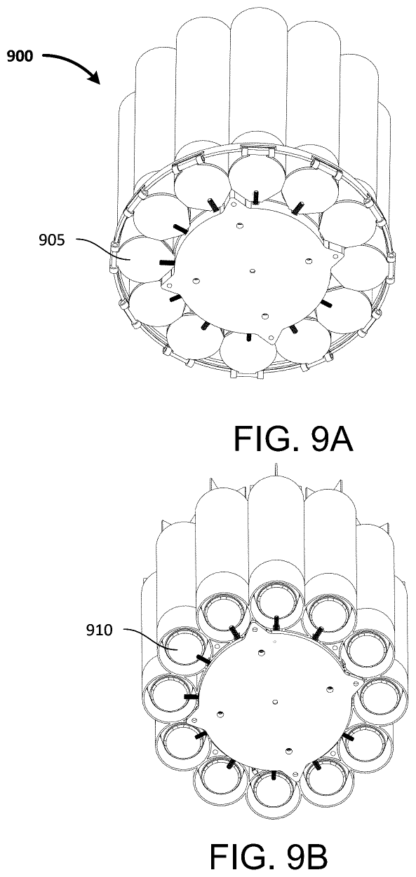

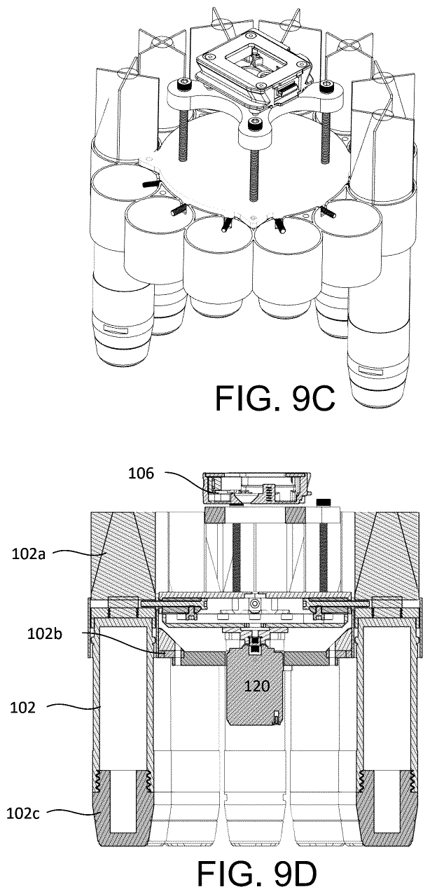

FIG. 9A-9D depicts a bottom, perspective, and cross-sectional exploded view of an exemplary LBDS 900. An exemplary pin mechanism 905 used to retain munitions 910 from the bottom of the LBDS. The bottom pins lock system may, for example, be used with trapdoors. The pin mechanism may, for example, be engaged in a groove and/or retention slot of munition. The munition may, for example, include various payloads (e.g., flares, smoke grenades, different types of explosives. The LBDS 900 includes a pogo stick mechanism 102b that electronically activates a spring mechanism release of the munition. The LBDS includes an exemplary mount 106. The container 102c (e.g., shape of tip) and the tail 102a (e.g., fin structure) may, for example, allow for easy insertion. The angled slope of the fin may, for example, push the pin back. The pushing back of the pin may, for example, engage the spring in the groove as depicted in FIG. 17C. An exemplary assembly view is presented in FIG. 17D. An exemplary cross-sectional view is presented in FIG. 17E.

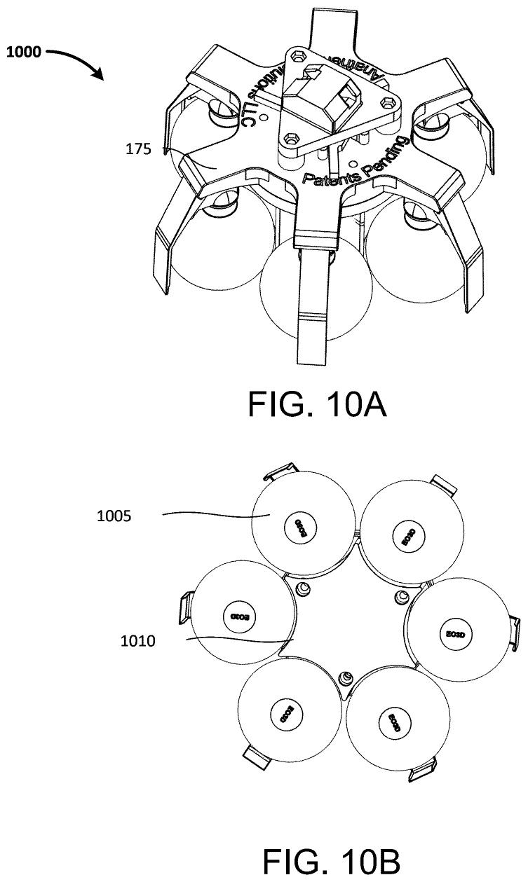

FIG. 10A-10B depicts a perspective and bottom view of an exemplary LBDS grenade munition configuration 1000. The grenade munition configuration includes an engagement frame system 175. The engagement frame system is stowing ordinances 1005 (e.g., grenades). The ordinances 1005 are supported stowed by a customized by plate 1010 which grooves contour to the ordinance on the rear of the aerial mount.

In some embodiments, the LBDS may, for example, include micro-radar Sensors. The system may, for example, employs micro-radar sensors. These sensors may, for example, be embedded within the grenades and mines and provide crucial data for decision-making. The sensors may, for example, be used to detect changes in proximity, movement, and potential obstacles in the deployment area.

In some implementations, the LBDS may, for example, include an electronic fuse. The electronic fuse may, for example, include a normally-closed (NC) switch, ensuring that the munition cannot detonate while the safety mechanism (e.g., spoon) is pressed. This switch may, for example, offers electronic control while retaining a hardware override for added safety.

In some implementations, the LBDS may, for example, include optional features. The LBDS may, for example, include solar panels and rechargeable batteries. Some embodiments may, for example, include solar panels and rechargeable batteries to extend the lifespan of the munitions.

The LBDS may, for example, include a GPS Puck. The GPS module may, for example, be added to facilitate demining efforts and populate a user interface (UI) map.

In some implementations, the LBDS may, for example, incorporate various sensors, including vibration sensors, Inertial Measurement Units (IMUs), radar or Time-of-Flight (TOF) sensors, and cameras for data collection and decision-making.

In some implementations, the LBDS may, for example, include mortars and smart munitions. Smart munitions may, for example, be deployed alongside mortars. The munitions may, for example, be dropped in strategic locations, either in front of or behind enemy trenches, and controlled remotely. This capability can disrupt enemy mobility within trenches and encourage retreat.

In some embodiments the LBDS may, for example, include an alternating drop. The system allows for alternating drop patterns, ensuring even distribution and coverage in the designated area.

In some embodiments the LBDS may, for example, include Airbursting. Distance (DX) sensors in the fuses may, for example, be programmed to determine the optimal height for detonation. This feature can be particularly useful when dealing with targets at varying altitudes.

Some embodiments, may, for example, include a spoon safety mechanism, ensuring that the munition cannot detonate when the spoon is pressed. This feature combines electronic control with a physical safety override.

Some embodiments may, for example, include a safety relay or safety Metal-Oxide-Semiconductor Field-Effect Transistor (MOSFET) can be added for manual activation by operators.

Some embodiments may, for example, include safety logic. Safety logic may, for example, prevent accidental detonations, safety logic can be implemented, including a minimum free-fall time and minimum velocity requirements.

Some munitions may, for example, be designed to completely cut communication with the launcher (e.g., drone). This feature enhances security and reduces the risk of interception.

Some munitions may, for example, be programmed to communicate timing information with the fuse, ensuring precise control over detonation,

Although an exemplary system has been described regarding FIGS. 1A-10B, other implementations may be deployed in different industrial, scientific, medical, commercial, and/or residential applications. The LBDS may, for example, be used to drop a canister filled with tourniquets, bandages, and/or medication supplies to personnel in a warzone field. In some implementations, for example, the LBDS may be configured to deliver printed goods (e.g., newspapers, advertisement flyers). In some implementations, the LBDS may be configured to deliver packages (e.g., e-commerce purchases).

In some implementations, the LBDS may, for example, be sold in kits with ordinances. The ordinance may, for example, include explosives, flash grenades, smoke grenades, flares, med kits, MRE backs, water, blood packs and/or other essential items in a battlefield. The LBDS may, for example, be used by the Red cross to render medical aid without using a weaponized LBDS.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or any combination.

For example, temporary auxiliary energy inputs may be received from chargeable or single-use batteries, which may enable use in portable or remote applications. Some embodiments may operate with other DC voltage sources, such as 9V (nominal) batteries, for example. Alternating current (AC) inputs, which may be provided, for example, from a 50/60 Hz power port or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The system components may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative aspect, an aerial load balancing delivery system (LBDS) 110B (some implementations may, for example, include LBDS 100A, and LBDS 100C as depicted in FIGS. 1A, 1B, and 1C) configured to be mounted on an unmanned aerial platform and to selectively deploy a plurality of munitions modules, the LBDS including: a lever engaging interlock engagement frame 150 releasably coupled to each of the plurality of munitions modules such that a physical interlock of each of the plurality of munitions is operated to physically obstruct activation of a corresponding detonation module, the plurality of munitions supported in a symmetrical arrangement in a horizontal plane; a servo motor 120 configured to selectively operate in response to a munitions deployment signal wherein the servo motor pushes the spring-loaded pin towards the munition to keep it from falling and to maintain the lever engaging frame's engagement with the interlock engagement frame; munition-retaining bolts 155 configured to restrict a position of the munition in a loading position such that the at least one munitions module is prevented from moving when the spring-loaded pin is being removed in the loading position; and a release frame 103 mechanically coupled to the motor such that the release frame rotates about an axis orthogonal to the horizontal plane in response to operation of the motor, the release frame comprising engagement features configured to translate a corresponding release the spring-loaded pins such that at least one of the plurality of munitions is released.

For example, the LBDS may, for example, include POGO ports configured to operate a digital fuse of the munition, such that a user operating remote controller is capable of generating a timed explosion by activating the digital fuse.

For example, the LBDS may, for example, include a distance sensor, such that the AMLDS activates the servo motor only at a height as a function of a fixed delay of the launched munition and a predetermined explosion height.

For example, the munitions may, for example, include, further comprising a distance sensor, such that the AMLDS activates the servo motor only at a height as a function of a fixed delay of the launched munition and a predetermined explosion height.

For example, the LBDS may, for example, include a multiple lever munitions holding units further including an deployment unit having a rotatable dispensing plate operably coupled to multiple lids configured to withhold a grenade during transportation, wherein the rotatable dispensing plate is configured to rotate about a central axis and comprising a dispensing aperture such that only one of the multiple lids are capable of opening at one time.

For example, the LBDS may, for example, include a deployment unit having a rotatable dispensing plate operably coupled to multiple lids configured to withhold the at least one munitions module during transportation, wherein the rotatable dispensing plate is configured to rotate about a central axis and comprising a dispensing aperture such that only one of the multiple lids is capable of opening at one time.

For example, the LBDS may, for example, include an embodiment wherein the munitions further include an electronic fuse activated upon removal of the safety pin, wherein, in a transportation mode, the electronic fuse is interrupted by the interlock of the munition, and in a deployment mode, the electronic fuse activate the detonation mechanism of the munition based on an activation signal received from a timer and/or a sensor (e.g., a gyroscope, an impact sensor, a combination of sensors) of the electronic fuse, and the electronic fuse includes a communication unit configured to receive the activation signal.

In an illustrative aspect, an aerial load balancing delivery system (LBDS) (100A, 100B, and/or 100C) may, for example, be configured to be mounted on an unmanned aerial platform and to selectively deploy a plurality of munitions modules, the LBDS including: an interlock engagement frame 150 releasably coupled to each of the plurality of munitions modules such that a physical interlock of each of the plurality of munitions is operated to physically obstruct activation of a corresponding detonation module, the plurality of munitions supported in a symmetrical arrangement in a horizontal plane; a motor 120 configured to selectively operate in response to a munitions deployment signal; a release frame 103 mechanically coupled to the motor such that the release frame rotates about an axis orthogonal to the horizontal plane in response to operation of the motor, the release frame comprising engagement features configured to translate a corresponding release pins such that at least one of the plurality of munitions is released, wherein the release frame 103 is configured such that operation of the motor in response to the munitions deployment signal sequentially releases opposing munitions about the axis, of the plurality of munitions, such that opposing torques are generated about an axis orthogonal to the axis of rotation.

For example, the LBDS may, for example, include multiple lever munition holding units symmetrically arranged in a horizontal plane, wherein, after the multiple lever munition holding units are loaded with munitions, the motor may be activated to rotate the plate configured with protrusions located on opposing sides of the plate to selectively deploy by the engagement of the protrusions located on opposing sides of the plate with the lever engaging frame such that a first munition and a second opposing munition deploy together to minimize a net torque generate by the release of the opposing munitions.

For example, the LBDS may, for example, include an embodiment wherein the lever engaging frame and the spring-loaded pin exert a force in opposite directions along a horizontal axis to deactivate the munition, such that the safety pin can be removed without activating the munition.

For example, the LBDS may, for example, include an embodiment, wherein the lever engaging frame and the spring-loaded pin exert a force in opposite directions along a horizontal axis to deactivate the munition, such that the safety pin can be removed without activating the munition.

For example, the LBDS may, for example, include an embodiment, wherein the motor is a servo motor a operably coupled to the spring-loaded pin, such that, in the stowage mode, the servo motor pushes the spring-loaded pin towards the munition to keep it from falling and to maintain the lever engaging frame's engagement with the interlock engagement frame.

For example, the LBDS may, for example, include munition-retaining bolts configured to restrict a position of the munition in a loading position such that the at least one munitions module is prevented from moving when the safety pin is being removed in the loading position.

T For example, the LBDS may, for example, include POGO ports configured to operate a digital fuse of the munition, such that a user operating remote controller is capable of generating a timed explosion by activating the digital fuse.

For example, the LBDS may include a distance sensor, such that the AMLDS activates the servo motor only at a height as a function of a fixed delay of the launched munition and a predetermined explosion height.

For example, the munitions may, for example, include a distance sensor, such that the AMLDS activates the servo motor only at a height as a function of a fixed delay of the launched munition and a predetermined explosion height.

For example, the LBDS may, for example, include an embodiment wherein the multiple lever munitions holding units further include a deployment unit having a rotatable dispensing plate operably coupled to multiple lids configured to withhold a grenade during transportation, wherein the rotatable dispensing plate is configured to rotate about a central axis and comprising a dispensing aperture such that only one of the multiple lids is capable of opening at one time.

For example, the LBDS may, for example, include a deployment unit having a rotatable dispensing plate operably coupled to multiple lids configured to withhold the at least one munitions module during transportation, wherein the rotatable dispensing plate is configured to rotate about a central axis and comprising a dispensing aperture such that only one of the multiple lids is capable of opening at one time.

For example, the LBDS may, for example, include an embodiment wherein the munition further includes an electronic fuse activated upon removal of the safety pin, wherein, in a transportation mode, the electronic fuse is interrupted by the spoon of the munition, and in a deployment mode, the electronic fuse activate the detonation mechanism of the munition based on an activation signal received from a timer and/or a sensor (e.g., a gyroscope, an impact sensor, a combination of sensors) of the electronic fuse.

For example, the LBDS may, for example, include an embodiment, wherein the electronic fuse includes a communication unit configured to receive the activation signal.

Some implementations have been described. Nevertheless, it will be understood that various modifications may be made. For example, advantageous results may be achieved if the steps of the disclosed techniques were performed in a different sequence, or if components of the disclosed systems were combined differently, or if the components were supplemented with other components. Accordingly, other implementations are contemplated.

What is claimed is:

1. An aerial load balancing delivery system (LBDS) 110B configured to be mounted on an unmanned aerial platform and to selectively deploy a plurality of munitions modules, the LBDS comprising:
a lever engaging interlock engagement frame 150 releasably coupled to each of the plurality of munitions modules such that a physical interlock of each of the plurality of munitions is operated to physically obstruct activation of a corresponding detonation module, the plurality of munitions supported in a symmetrical arrangement in a horizontal plane;
a servo motor 120 configured to selectively operate in response to a munitions deployment signal wherein the servo motor pushes the spring-loaded pin towards the munition to keep it from falling and to maintain the lever engaging frame's engagement with the interlock engagement frame;
munition-retaining bolts 155 configured to restrict a position of the munition in a loading position such that the at least one munitions module is prevented from moving when the spring-loaded pin is being removed in the loading position; and
a release frame 103 mechanically coupled to the motor such that the release frame rotates about an axis orthogonal to the horizontal plane in response to operation of the motor, the release frame comprising engagement features configured to translate a corresponding release the spring-loaded pins such that at least one of the plurality of munitions is released.

2. The LBDS of claim 1, further comprising POGO ports configured to operate a digital fuse of the munition, such that a user operating remote controller is capable of generating a timed explosion by activating the digital fuse.

3. The LBDS of claim 1, further comprising a distance sensor, such that the AMLDS activates the servo motor only at a height as a function of a fixed delay of the launched munition and a predetermined explosion height.

4. The munitions of claim 1, further comprising a distance sensor, such that the AMLDS activates the servo motor only at a height as a function of a fixed delay of the launched munition and a predetermined explosion height.

5. The LBDS of claim 1, further comprising a multiple lever munitions holding units further comprising an deployment unit having a rotatable dispensing plate operably coupled to multiple lids configured to withhold a grenade during transportation, wherein the rotatable dispensing plate is configured to rotate about a central axis and comprising a dispensing aperture such that only one of the multiple lids are capable of opening at one time.

6. The LBDS of claim 1, a deployment unit having a rotatable dispensing plate operably coupled to multiple lids configured to withhold the at least one munitions module during transportation, wherein the rotatable dispensing plate is configured to rotate about a central axis and comprising a dispensing aperture such that only one of the multiple lids is capable of opening at one time.

7. The LBDS of claim 1, wherein the munitions further comprises an electronic fuse activated upon removal of the safety pin, wherein, in a transportation mode, the electronic fuse is interrupted by the interlock of the munition, and in a deployment mode, the electronic fuse activate the detonation mechanism of the munition based on an activation signal received from a timer and/or a sensor (e.g., a gyroscope, an impact sensor, a combination of sensors) of the electronic fuse, and the electronic fuse includes a communication unit configured to receive the activation signal.

8. An aerial load balancing delivery system (LBDS) configured to be mounted on an unmanned aerial platform and to selectively deploy a plurality of munitions modules, the LBDS comprising:
an interlock engagement frame 150 releasably coupled to each of the plurality of munitions modules such that a physical interlock of each of the plurality of munitions is operated to physically obstruct activation of a corresponding detonation module, the plurality of munitions supported in a symmetrical arrangement in a horizontal plane;
a motor 120 configured to selectively operate in response to a munitions deployment signal;
a release frame 103 mechanically coupled to the motor such that the release frame rotates about an axis orthogonal to the horizontal plane in response to operation of the motor, the release frame comprising engagement features configured to translate a corresponding release pins such that at least one of the plurality of munitions is released,
wherein the release frame 103 is configured such that operation of the motor in response to the munitions deployment signal sequentially releases opposing munitions about the axis, of the plurality of munitions, such that opposing torques are generated about an axis orthogonal to the axis of rotation.

9. The LBDS of claim 8, further comprising multiple lever munition holding units symmetrically arranged in a horizontal plane, wherein, after the multiple lever munition holding units are loaded with munitions, the motor may be activated to rotate the plate configured with protrusions located on opposing sides of the plate to selectively deploy by the engagement of the protrusions located on opposing sides of the plate with the lever engaging frame such that a first munition and a second opposing munition deploy together to minimize a net torque generate by the release of the opposing munitions.

10. The LBDS of claim 8, wherein the lever engaging frame and the spring-loaded pin exert a force in opposite directions along a horizontal axis to deactivate the munition, such that the safety pin can be removed without activating the munition.

11. The LBDS of claim 8, wherein the lever engaging frame and the spring-loaded pin exert a force in opposite directions along a horizontal axis to deactivate the munition, such that the safety pin can be removed without activating the munition.

12. The LBDS of claim 8, wherein the motor is a servo motor a operably coupled to the spring-loaded pin, such that, in the stowage mode, the servo motor pushes the spring-loaded pin towards the munition to keep it from falling and to maintain the lever engaging frame's engagement with the interlock engagement frame.

13. The LBDS of claim 8, further comprising munition-retaining bolts configured to restrict a position of the munition in a loading position such that the at least one munitions module is prevented from moving when the safety pin is being removed in the loading position.

14. The LBDS of claim 8, further comprising POGO ports configured to operate a digital fuse of the munition, such that a user operating remote controller is capable of generating a timed explosion by activating the digital fuse.

15. The LBDS of claim 8, further comprising a distance sensor, such that the AMLDS activates the servo motor only at a height as a function of a fixed delay of the launched munition and a predetermined explosion height.

16. The munitions of claim 8, further comprising a distance sensor, such that the AMLDS activates the servo motor only at a height as a function of a fixed delay of the launched munition and a predetermined explosion height.

17. The LBDS of claim 8, wherein the multiple lever munitions holding units further comprise a deployment unit having a rotatable dispensing plate operably coupled to multiple lids configured to withhold a grenade during transportation, wherein the rotatable dispensing plate is configured to rotate about a central axis and comprising a dispensing aperture such that only one of the multiple lids is capable of opening at one time.

18. The LBDS of claim 8, a deployment unit having a rotatable dispensing plate operably coupled to multiple lids configured to withhold the at least one munitions module during transportation, wherein the rotatable dispensing plate is configured to rotate about a central axis and comprising a dispensing aperture such that only one of the multiple lids is capable of opening at one time.

19. The LBDS of claim 8, wherein the munition further comprises an electronic fuse activated upon removal of the safety pin, wherein, in a transportation mode, the electronic fuse is interrupted by the spoon of the munition, and in a deployment mode, the electronic fuse activate the detonation mechanism of the munition based on an activation signal received from a timer and/or a sensor (e.g., a gyroscope, an impact sensor, a combination of sensors) of the electronic fuse.

20. The LBDS of claim 19, wherein the electronic fuse includes a communication unit configured to receive the activation signal.
